(19) United States
(12) Patent Application Publication
(10) Pub. No.: US 2025/0271397 A1
(43) Pub. Date: Aug. 28, 2025

(54) Inspection Apparatus and Inspection Method

(71) Applicant: Hitachi-GE Nuclear Energy, Ltd., Hitachi-shi (JP)

(72) Inventors: So KITAZAWA, Tokyo (JP); Junta YAMADA, Hitachi-shi (JP); Yoshizumi FUKUHARA, Hitachi-shi (JP); Akihiko HIRANO, Hitachi-shi (JP); Michiaki KUROSAKI, Hitachi-shi (JP)

(21) Appl. No.: 19/028,588

(22) Filed: Jan. 17, 2025

(30) Foreign Application Priority Data
Feb. 22, 2024 (JP) 2024-025316

(51) Int. Cl. G01N 29/04; G01N 29/11; G01N 29/48

(52) U.S. Cl. CPC G01N 29/043; G01N 29/11; G01N 29/48; G01N 2291/015; G01N 2291/02854; G01N 2291/104

(57) ABSTRACT

Provided are an inspection apparatus and an inspection method capable of two-dimensionally detecting a range of recession. The inspection apparatus includes a probe group, an ultrasonic waveform recording unit (recording unit), and a computation unit. The probe group includes a plurality of vertical probes that are attached to the surface of an inspection target object and transmit and receive ultrasonic waves. The recording unit records a plurality of reception signals obtained by receiving the ultrasonic wave transmitted from a first probe by a plurality of probes other than the first probe. The computation unit calculates a plurality of attenuation indexes representing degrees of attenuation of a plurality of second reception signals received after a plurality of first reception signals, with respect to the plurality of first reception signals recorded before an occurrence of recession in the inspection target object among the plurality of reception signals.

### TECHNICAL FIELD

The present invention relates to an inspection apparatus and an inspection method for inspecting the presence or absence of recession occurring in a structure such as a pipe.

### BACKGROUND ART

Conventionally, in a nuclear power plant, a thermal power plant, or the like, a crack inspection and a wall thickness inspection by ultrasonic waves are performed in periodic inspection. In non-destructive inspection using ultrasonic waves, the presence or absence of deterioration of a target object can be inspected in a state where the target object is disposed. Thus, the non-destructive inspection using ultrasonic waves is utilized in a wide range of fields because the cost required for inspection is low and application is easy.

PTL 1 discloses an inspection apparatus and an inspection method capable of inspecting the presence or absence of recession and defects occurring in a structure such as a pipe. The inspection apparatus disclosed in PTL 1 includes a plurality of probes that are attached to be perpendicular to a surface of an inspection target object and transmits and receives ultrasonic waves, a signal line, and a signal processor.

The probe emits an ultrasonic wave in a conical shape in a direction different from the vertical direction when transmitting the ultrasonic wave to be perpendicular to the inner surface of the inspection target object. The ultrasonic wave emitted in the vertical direction is reflected by the inner surface of the inspection target object and then received by the probe that has transmitted the ultrasonic wave. The ultrasonic wave emitted in the direction different from the vertical direction is repeatedly reflected and propagated on the inner surface and the surface of the inspection target object, and is received by another probe adjacent to the probe that has transmitted the ultrasonic wave.

The signal processor analyzes the ultrasonic wave that has been emitted and reflected in the vertical direction and the ultrasonic wave that has been emitted and reflected in the direction different from the vertical direction. As a result, the inspection apparatus disclosed in PTL 1 inspects the presence or absence of recession and defects even at a position other than immediately below the probe.

### CITATION LIST

### Patent Literature

PTL 1: JP 2022-163592 A

### SUMMARY OF INVENTION

### Technical Problem

Incidentally, in many cases, the recession occurring in a pipe may have a two-dimensional spread across a plurality of probes installed in a lattice shape or the like as disclosed in PTL 1. Then, in the recession inspection in recent years, it is required to ascertain the two-dimensional spread of recession. However, the inspection apparatus disclosed in PTL 1 ascertains the presence or absence of recession and the thickness between adjacent probes, but cannot ascertain the two-dimensional spread of the recession.

Considering the above problems, an object of the present invention is to provide an inspection apparatus and an inspection method capable of two-dimensionally detecting a range of recession.

### Solution to Problem

In order to solve the above problems and achieve the object, an inspection apparatus reflecting an aspect of the present invention inspects non-destruction of an inspection target object, and includes a probe group, a recording unit, and a computation unit. The probe group includes a plurality of probes that are attached to be perpendicular to the surface of the inspection target object, and transmit and receive ultrasonic waves. The recording unit records a plurality of reception signals obtained by receiving the ultrasonic wave transmitted from a first probe by a plurality of probes other than the first probe. The computation unit calculates a plurality of attenuation indexes representing degrees of attenuation of a plurality of second reception signals received after a plurality of first reception signals, with respect to the plurality of first reception signals recorded before an occurrence of recession in the inspection target object among the plurality of reception signals. Then, the computation unit detects a range of recession based on the plurality of attenuation indexes.

An inspection method reflecting another aspect of the present invention is a method of inspecting non-destruction of an inspection target object by using a reception signal acquired from a probe group including a plurality of probes that are attached to be perpendicular to a surface of the inspection target object, and transmit and receive ultrasonic waves. In the inspection method, the recording unit records a plurality of reception signals obtained by receiving the ultrasonic wave transmitted from a first probe by a plurality of probes other than the first probe. Then, the computation unit calculates a plurality of attenuation indexes representing degrees of attenuation of a plurality of second reception signals received after a plurality of first reception signals, with respect to the plurality of first reception signals recorded before an occurrence of recession in the inspection target object among the plurality of reception signals. Then, the computation unit detects a range of recession based on the plurality of attenuation indexes.

### Advantageous Effects of Invention

According to the inspection apparatus and the inspection method configured as described above, it is possible to two-dimensionally detect the range of recession.

### BRIEF DESCRIPTION OF DRAWINGS

FIG. 1 is a schematic diagram illustrating an overall configuration of an inspection apparatus according to a first embodiment.

FIG. 2 is a block diagram illustrating functions of an ultrasonic transmission and reception device according to the first embodiment.

FIG. 3 is a diagram illustrating an acoustic wave intensity distribution of a probe according to the first embodiment.

FIG. 4 is a diagram illustrating propagation of an ultrasonic wave in a case where a plurality of probes of the inspection apparatus according to the first embodiment is attached to a pipe.

FIG. 5 is a diagram illustrating propagation of ultrasonic waves emitted from a plurality of probes in a case where recession has occurred in a pipe.

FIG. 6A is a diagram illustrating an ultrasonic waveform received in a case where recession does not occur, and FIG. 6B is a diagram illustrating an ultrasonic waveform received when the recession has occurred.

FIG. 7 is a flowchart illustrating an example of a recession inspection procedure according to the first embodiment.

FIG. 8 is a flowchart illustrating an example of a recession distribution measurement process according to the first embodiment.

FIG. 9 is a diagram illustrating positions of a plurality of probes arranged in a lattice shape on a pipe.

FIG. 10 is a diagram illustrating the positions of the plurality of probes illustrated in FIG. 9 in a planar coordinate system.

FIG. 11 is a diagram illustrating a result of plotting a value of an attenuation rate on a straight line connecting positions of two probes in all combinations of positions of two probes in the planar coordinate system illustrated in FIG. 10.

FIG. 12 is a diagram illustrating a state in which a recession range is extracted from a state illustrated in FIG. 11.

FIG. 13 is a diagram illustrating a state in which the state illustrated in FIG. 12 is converted into a three-dimensional coordinate system.

FIG. 14 is a diagram illustrating propagation of an ultrasonic wave emitted from a probe in a case where elliptical recession has occurred in a pipe.

FIG. 15 is a diagram illustrating propagation of an ultrasonic wave emitted from a probe in a case where slit-shaped recession has occurred in a pipe.

FIG. 16 is a graph showing a relationship between the attenuation rate according to the shape of recession and the depth of recession.

FIG. 17 is a diagram illustrating a result of plotting a value of an attenuation rate on a straight line connecting positions of two probes in all combinations of positions of two probes in a measurement range according to a second embodiment.

FIG. 18 is a diagram for describing an example of measuring ultrasonic waveform signals at all positions of a plurality of probes by shifting the measurement range according to the second embodiment.

### DESCRIPTION OF EMBODIMENTS

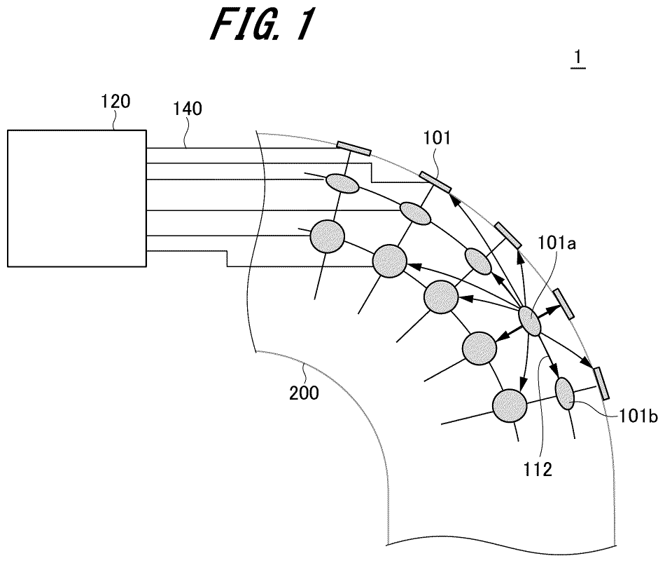

Hereinafter, an inspection apparatus and an inspection method according to embodiments will be described with reference to FIGS. 1 to 18. Note that, in the drawings used in the present specification, the same or corresponding components are denoted by the same or similar reference signs, and repetitive description of the components may be omitted.

An inspection apparatus for inspecting recession and defects of a pipe will be described as an example in the following embodiments, but an inspection apparatus and an inspection method according to the present invention are not limited thereto, and can be applied to inspection of a wide variety of structures.

### 1. First Embodiment

### [Configuration of Inspection Apparatus]

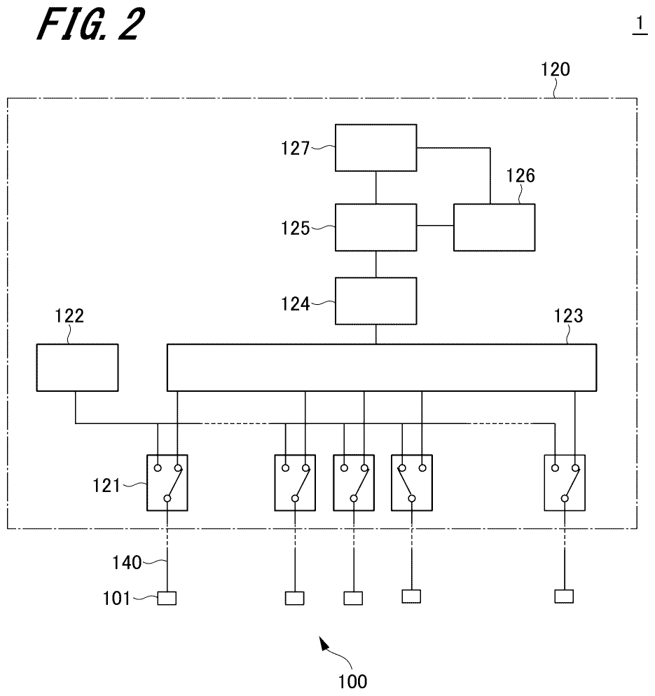

First, a configuration of an inspection apparatus according to a first embodiment will be described with reference to FIGS. 1 and 2.

FIG. 1 is a schematic diagram illustrating an overall configuration of the inspection apparatus according to the first embodiment. FIG. 2 is a block diagram illustrating functions of an ultrasonic transmission and reception device according to the first embodiment.

An inspection apparatus 1 illustrated in FIG. 1 is an apparatus used for non-destructive inspection of a pipe 200 installed in a plant. The inspection apparatus 1 is used to inspect the presence or absence of recession of the pipe 200 and the presence or absence of a defect. Note that the defect of the pipe 200 is, for example, an occurrence of a fracture or a flaw in the pipe 200. In the present embodiment, a defect such as a fracture or a flaw may be described as a part of recession.

As illustrated in FIG. 1, the inspection apparatus 1 includes a probe group 100 attached to the outer surface of the pipe 200 and an ultrasonic transmission and reception device 120. FIG. 1 illustrates an elbow portion of the pipe 200. The elbow portion is particularly a portion where recession is likely to occur. Note that the place where the probe group 100 is attached is not limited to the curved elbow portion, and may be a straight pipe portion having a linear shape.

The probe group 100 includes a plurality of vertical probes 101. The plurality of vertical probes 101 are arranged in a lattice shape. Note that the arrangement of the plurality of vertical probes 101 is not limited to the lattice shape, and may be, for example, a staggered shape or an irregular arrangement. The number of the plurality of vertical probes 101 is determined according to the size of a region as an inspection target of the pipe 200 and the structure of the pipe 200.

A guideline regarding the arrangement of the plurality of vertical probes is described in, for example, “The Japan Society of Mechanical Engineers, Japan, Standard of Nuclear Power Plant for Power Generation: Technical Standard for Boiling-water Nuclear Power Plant Pipe Recession Management (2006 edition)”. In this standard, the measurement pitch for the pipe diameter 125 A or less is defined as 4 or more points in the circumferential direction, and the measurement length of the downstream straight pipe portion of the pipe diameter 125 A or less is defined as 2 D (D is the pipe diameter) or a smaller one of 100 mm in the axial direction. In addition, the measurement pitch of a pipe having a diameter exceeding the pipe diameter 125 A is defined as 8 or more points in the circumferential direction, and the measurement length of the downstream straight pipe portion of the pipe having a diameter exceeding the pipe diameter 125 A is defined as 100 mm in the axial direction.

The dimension of the lattice in the present embodiment can be set to, for example, a width of 50 mm or the like. As a result, it is possible to satisfy the above standard. Note that the arrangement of the plurality of vertical probes 101 can be appropriately determined according to various inspection target standards and a range of recession intended to be detected.

The plurality of vertical probes 101 are fixed to the pipe 200 at a posture in which a portion for transmitting and receiving an ultrasonic wave is substantially perpendicular to the outer surface of the pipe 200. For example, an adhesive that has heat resistance and is capable of transmitting acoustic waves is used for fixing the plurality of vertical probes 101. As a result, the plurality of vertical probes 101 can be used not only while the plant is stopped but also while the plant is in operation.

The plurality of vertical probes 101 are connected to the ultrasonic transmission and reception device 120 via a signal line 140. Signal transmission means between the plurality of vertical probes 101 and the ultrasonic transmission and reception device 120 is not limited to wired means, and may be wireless means.

### [Functional Configuration of Ultrasonic Transmission and Reception Device]

Next, a functional configuration of the ultrasonic transmission and reception device 120 will be described with reference to FIG. 2.

FIG. 2 is a block diagram illustrating functions of the ultrasonic transmission and reception device 120.

As illustrated in FIG. 2, the ultrasonic transmission and reception device 120 includes a plurality of changeover switches 121, a pulsar receiver 122, a multiplexer 123, an amplifier 124, an ultrasonic waveform recording unit 125, a storage unit 126, and a computation unit 127.

The plurality of changeover switches 121 are connected to the plurality of vertical probes 101 via a signal line 140. The changeover switch 121 is a double-throw switch. The pulsar receiver 122 is connected to one contact point of the changeover switch 121, and the multiplexer 123 is connected to the other contact point. The multiplexer 123 is connected to the ultrasonic waveform recording unit 125 through the amplifier 124. Each of the storage unit 126 and the computation unit 127 is connected to the ultrasonic waveform recording unit 125.

The pulsar receiver 122 applies a pulsed voltage to the vertical probe 101 through the changeover switch 121. As a result, the vertical probe 101 emits pulsed ultrasonic waves toward the inner surface side of the pipe 200. Note that the voltage applied to the vertical probe 101 is not limited to a pulse shape. For example, a voltage signal that varies sinusoidally may be continuously applied to the probe according to the present invention.

The multiplexer 123 receives ultrasonic waveform signals transmitted from the plurality of vertical probes 101, and outputs the ultrasonic waveform signals to the amplifier 124. The ultrasonic waveform signal corresponds to a reception signal according to the present invention. The amplifier 124 amplifies the ultrasonic waveform signal transmitted from the multiplexer 123 and outputs the ultrasonic waveform signal to the ultrasonic waveform recording unit 125.

The ultrasonic waveform recording unit 125 records the ultrasonic waveform signal amplified by the amplifier 124. The storage unit 126 stores the ultrasonic waveform signal recorded by the ultrasonic waveform recording unit 125. The computation unit 127 calculates an attenuation rate of the ultrasonic waveform signal. In addition, the computation unit 127 detects the range of recession based on the calculated attenuation rate. The attenuation rate is an attenuation index representing the degree of attenuation of the ultrasonic waveform signal.

[Propagation of Ultrasonic Wave Emitted from Vertical Probe]

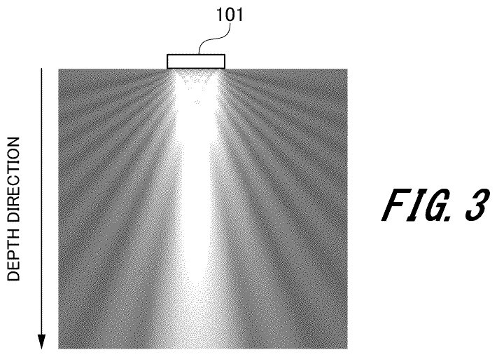

Next, propagation of an ultrasonic wave emitted from the vertical probe 101 will be described with reference to FIGS. 3 to 6.

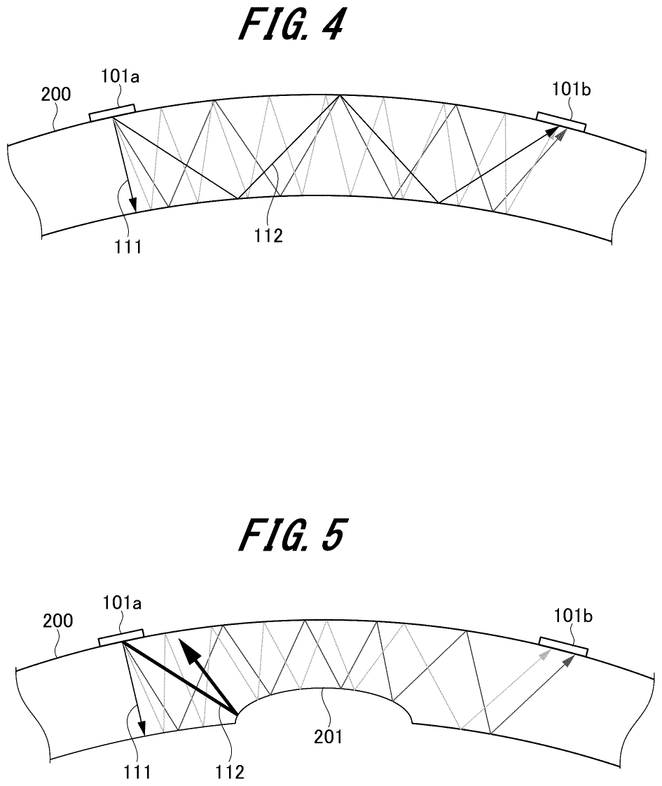

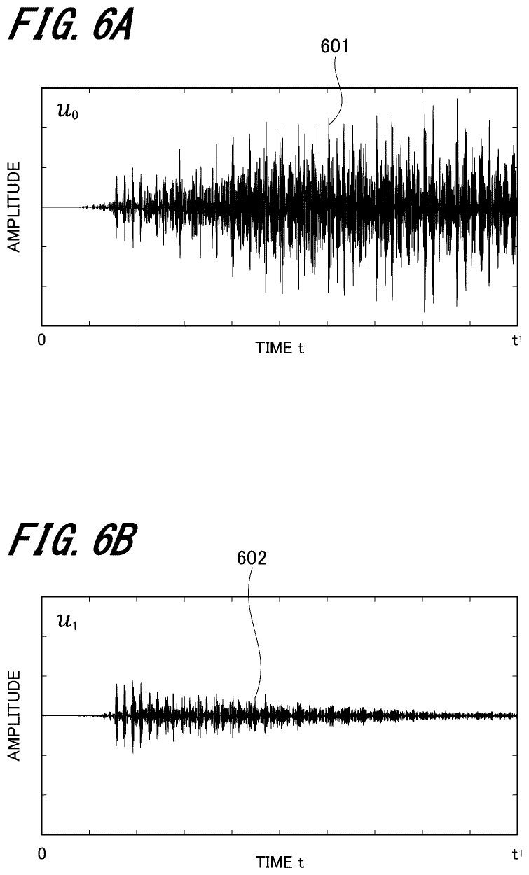

FIG. 3 is a diagram illustrating an acoustic wave intensity distribution of the vertical probe 101. FIG. 4 is a diagram illustrating propagation of an ultrasonic wave in a case where the plurality of vertical probes 101 are attached to the pipe 200. FIG. 5 is a diagram illustrating propagation of ultrasonic waves emitted from a plurality of vertical probes 101 in a case where recession has occurred in the pipe 200. FIG. 6 is a diagram illustrating waveforms of reception signals in a case where recession does not occur and in a case where recession has occurred.

A bright color portion illustrated in FIG. 3 indicates that the intensity of the ultrasonic wave is high, and a dark color portion indicates that the intensity is low. As illustrated in FIG. 3, an ultrasonic wave emitted from the vertical probe 101 travels in a directly downward direction and an obliquely downward direction. The intensity of the ultrasonic wave traveling in the directly downward direction is larger than the intensity of the ultrasonic wave traveling in the obliquely downward direction. Note that the ultrasonic wave directed in the obliquely downward direction has components of various angles continuously.

As illustrated in FIG. 4, an ultrasonic wave 111 that is emitted from a vertical probe 101a attached to the pipe 200 and travels in the directly downward direction is reflected by the inner surface of the pipe 200 and received by the vertical probe 101a. On the other hand, an ultrasonic wave 112 that is emitted from the vertical probe 101a and travels in the obliquely downward direction is multiple-reflected and propagated on the inner surface of the pipe 200. Then, the ultrasonic wave 112 is received by a vertical probe 101b that is a vertical probe other than the vertical probe 101a.

As illustrated in FIG. 1, not only the vertical probe 101b but also a plurality of vertical probes 101 other than the vertical probe 101a are located around the vertical probe 101a. Thus, an ultrasonic wave that is emitted from the vertical probe 101a and travels in the obliquely downward direction is received by a plurality of vertical probes 101 including the vertical probe 101b.

An ultrasonic wave 112 illustrated in FIG. 5 is an ultrasonic wave having the same emission angle as that of the ultrasonic wave 112 illustrated in FIG. 4. As illustrated in FIG. 5, in a case where recession 201 has occurred in the pipe 200, the ultrasonic wave 112 that is emitted from the vertical probe 101a and travels in the obliquely downward direction is reflected by the inclined surface of the recession 201 and propagates in a direction opposite to the vertical probe 101b. The ultrasonic wave reflected by the inclined surface of the recession increases as the depth of recession increases.

As a result, the amount of ultrasonic waves transferred from the vertical probe 101a to the vertical probe 101b decreases as the depth of recession increases. As a result, the intensity of the ultrasonic waveform that is transmitted by the vertical probe 101a and then received by the vertical probe 101b decreases.

FIG. 6A is a diagram illustrating an ultrasonic waveform 601 received in a case where recession does not occur. FIG. 6B is a diagram illustrating an ultrasonic waveform 602 received in a case where recession has occurred. In FIG. 6, the horizontal axis represents time, and the vertical axis represents the amplitude of an ultrasonic waveform. The vertical axes in FIGS. 6A and 6B are the same scale.

In a case where the recession has occurred, the slope surface of the recession shields some ultrasonic waves. Therefore, the amplitude of the ultrasonic waveform 602 is smaller than the amplitude of the ultrasonic waveform 601. In the present embodiment, a decrease in the amplitude of the ultrasonic waveform is detected to estimate the distribution of the recession.

### [Recession Inspection Procedure]

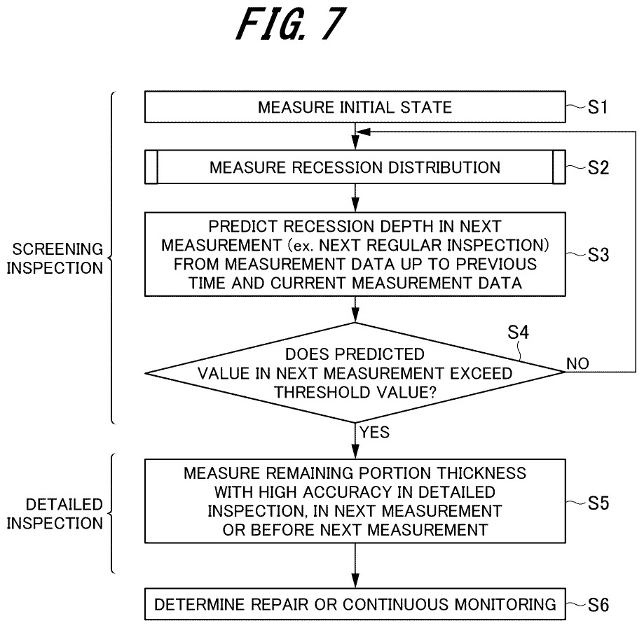

Next, a procedure of recession inspection using the inspection apparatus 1 according to the present embodiment will be described with reference to FIG. 7.

FIG. 7 is a flowchart illustrating an example of a recession inspection procedure according to the present embodiment.

The recession inspection is divided into a screening inspection and a detailed inspection. In the recession inspection, first, the screening inspection is periodically performed by using the inspection apparatus 1 according to the present embodiment. Then, in the screening inspection, when the evaluation value of the recession exceeds a threshold value set in advance, the detailed inspection is performed.

In the screening inspection, first, the inspection apparatus 1 executes an initial state measurement process (S1). The initial state is a state in which recession does not occur in the pipe 200. Examples of the initial state include time when the pipe 200 is installed and time when the pipe 200 is replaced with a new one.

In the initial state measurement process, the ultrasonic waveform recording unit 125 of the inspection apparatus 1 records an ultrasonic waveform signal (referred to as an “ultrasonic waveform signal in an initial state” below) obtained by receiving an ultrasonic wave propagating between two vertical probes 101, for each combination of the two vertical probes among the plurality of vertical probes 101. Then, the storage unit 126 stores the ultrasonic waveform signal in the initial state recorded by the ultrasonic waveform recording unit 125. The ultrasonic waveform signal in the initial state corresponds to a first reception signal according to the present invention.

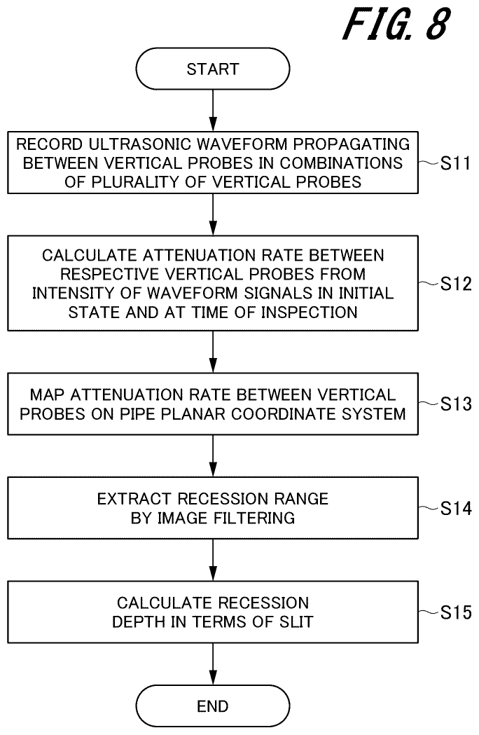

Then, the inspection apparatus 1 executes a recession distribution measurement process (S2). The recession distribution measurement process is executed every time a predetermined period elapses. In the recession distribution measurement process, the inspection apparatus 1 two-dimensionally detects a range where recession has occurred and calculates the depth of the recession. The recession distribution measurement process will be described later with reference to FIG. 8.

Then, the inspection apparatus 1 predicts the depth of recession in the next measurement, based on the measurement data up to the previous time and the current measurement data obtained in Step S2 (S3). Then, the inspection apparatus 1 determines whether or not the depth of recession (evaluation value of recession) in the next measurement, which has been predicted in Step S3, exceeds a predetermined threshold value (S4).

When it is determined in Step S4 that the evaluation value of recession does not exceed the predetermined threshold value (NO in S4), the inspection apparatus 1 executes the process of Step S2 after a predetermined period has elapsed. On the other hand, when it is determined in Step S4 that the evaluation value of recession exceeds the predetermined threshold value (YES in S4), the inspection apparatus 1 determines that detailed inspection is required.

In a case where it is determined by the inspection apparatus 1 that the detailed inspection is required, an inspector performs the detailed inspection at the time of execution of the next recession distribution measurement process or before the next recession distribution measurement process, and measures the depth of recession (thickness of the remaining portion) with high accuracy (S5). In the detailed inspection, the place and the depth of recession are measured in detail by using a conventional inspection apparatus that measures recession by using an ultrasonic wave emitted from a vertical probe in a directly downward direction.

Then, the inspection apparatus 1 determines either repair or continuous monitoring based on the result of the detailed inspection in Step S5 (S6). Then, the inspection apparatus transmits the determination result to a company (plant business operator) that manages the pipe 200.

### [Recession Distribution Measurement Process]

Next, the recession distribution measurement process executed in Step S2 of the recession inspection procedure illustrated in FIG. 7 will be described with reference to FIG. 8.

FIG. 8 is a flowchart illustrating an example of the recession distribution measurement process.

First, the ultrasonic waveform recording unit 125 of the inspection apparatus 1 records an ultrasonic waveform signal (referred to as an “ultrasonic waveform signal at time of inspection” below) obtained by receiving an ultrasonic wave propagating between two vertical probes 101, for each combination of the two vertical probes among the plurality of vertical probes 101 (S11). The ultrasonic waveform signal at the time of inspection corresponds to a second reception signal according to the present invention. The storage unit 126 stores the ultrasonic waveform signal at the time of inspection, which has been recorded by the ultrasonic waveform recording unit 125. Note that the storage unit 126 stores the ultrasonic waveform signal in the initial state described above.

Then, the computation unit 127 calculates an attenuation rate η of the ultrasonic waveform signal at the time of inspection with respect to the ultrasonic waveform signal in the initial state (S12). The attenuation rate η is calculated by using the following Expression (1).

$$\begin{matrix}[ Math . 1 ] & \\ η = ( {P}_{0} - {P}_{1} ) / {P}_{0} & ( 1 )\end{matrix}$$

P₀ in Expression (1) is the energy of the ultrasonic waveform signal in the initial state, and is calculated by using the following Expression (2). P₁ is the energy of the ultrasonic waveform signal at the time of inspection, and is calculated by using the following Expression (3).

$$\begin{matrix}[ Math . 2 ] & \\ {P}_{0} = {\int }_{0}^{{t}_{1}} {\vert {u}_{0} ( t ) \vert}^{2} dt & ( 2 )\end{matrix}$$

$$\begin{matrix}[ Math . 3 ] & \\ {P}_{1} = {\int }_{0}^{{t}_{1}} {\vert {u}_{1} ( t ) \vert}^{2} dt & ( 3 )\end{matrix}$$

u₀ in Expression (2) is the ultrasonic waveform signal in the initial state. u₁ in Expression (3) is the ultrasonic waveform signal at the time of inspection. t₁ in Expressions (2) and (3) is the maximum value of the recording time of the ultrasonic waveform signal. However, an integration range may be common between u₀ and u₁, and is not necessarily limited to t₁. As described above, the attenuation rate η can be easily calculated by using Expression (1). Note that there is a method of representing the degree of attenuation of the waveform intensity in addition to Expression (1). Therefore, the attenuation rate according to the present invention is not limited to being calculated by using Expression (1).

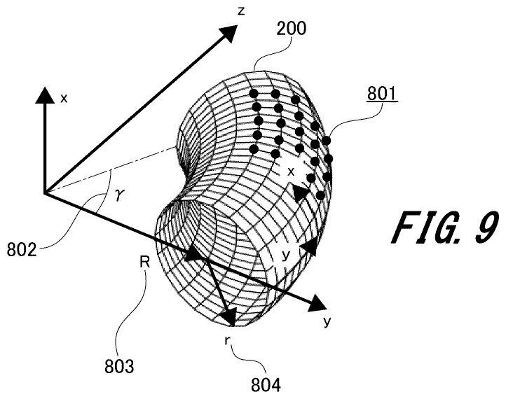

Then, the computation unit 127 maps the attenuation rate between the vertical probes 101 on the planar coordinate system of the pipe 200 (S13). FIG. 9 is a diagram illustrating positions 801 of a plurality of vertical probes 101 arranged in a lattice shape on the pipe 200. As described above, the positions 801 of the plurality of vertical probes 101 do not necessarily need to be set in a lattice shape, and may be arranged in a staggered shape or any other arrangement having regularity, or may be arranged randomly without regularity.

As illustrated in FIG. 9, the interval between the positions 801 along the axial direction of the pipe 200 becomes wide on the back side (outer peripheral side) of the pipe 200 and becomes narrow on the front side (inner peripheral side) of the pipe 200. In order to represent the position 801 in the planar coordinate system, plane development is performed in the axial direction and the circumferential direction by using an elbow angle 802 (γ), an elbow curvature radius 803 (R), and a pipe radius 804 (r) of the pipe 200.

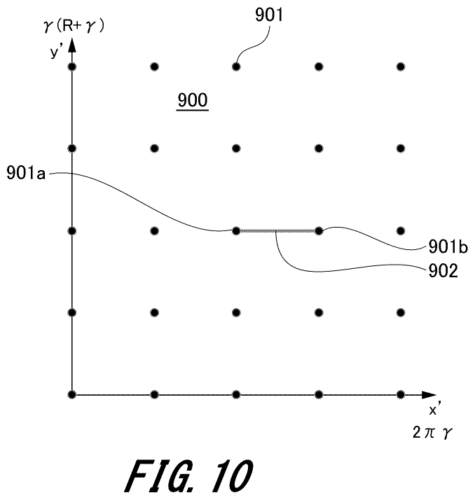

FIG. 10 is a diagram illustrating the position 801 illustrated in FIG. 9 in a planar coordinate system 900. A position 901 in FIG. 10 corresponds to the position 801 illustrated in FIG. 9. In Step S13, for example, the values of the attenuation rates corresponding to the positions 901a and 901b are plotted on a straight line 902 connecting the positions 901a and 901b. In Step S13, the computation unit 127 plots the values of the attenuation rates for all combinations of the positions 901 of the two vertical probes 101.

The number of plots can be freely set. For example, the number of plots in a case where a distance between the position 901a and the position 901b is 50 mm, and plotting is performed every 0.1 mm is 500. As the number of plots increases, the resolution increases. Thus, it is possible to estimate the range of recession with high accuracy.

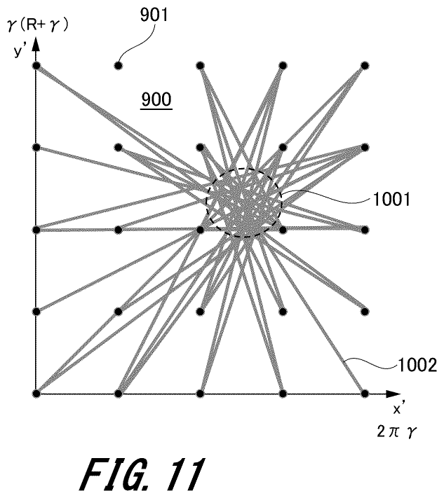

FIG. 11 is a diagram illustrating a state in which values of attenuation rates are plotted on a straight line connecting the positions 901 of the two vertical probes 101 in all combinations of the positions 901 of the two vertical probes 101 illustrated in FIG. 10. In FIG. 11, a straight line in which the value of the attenuation rate is 0 is not drawn. FIG. 11 illustrates a straight line in which the value of the attenuation rate is more than 0, that is, a straight line 1002 crossing a recession range 1001.

At the point where the straight lines 1002 intersect, the values of the attenuation rates in both the straight lines are summed. The sum of the values of the attenuation rate is summed by using a well-known interpolation method such as a linear interpolation method. As illustrated in FIG. 11, a range in which the straight lines 1002 largely overlap can be estimated as the recession range. As a result, it is possible to easily detect the recession range having a two-dimensional spread across the plurality of vertical probes 101.

Then, the computation unit 127 performs image filtering on the planar coordinate system 900 illustrated in FIG. 11 to extract the recession range (S14 in FIG. 8). In Step S14, the computation unit 127 applies a two-dimensional low-pass filter to the planar coordinate system illustrated in FIG. 11, and extracts a range in which the sum of the values of the attenuation rate is equal to or greater than a threshold value.

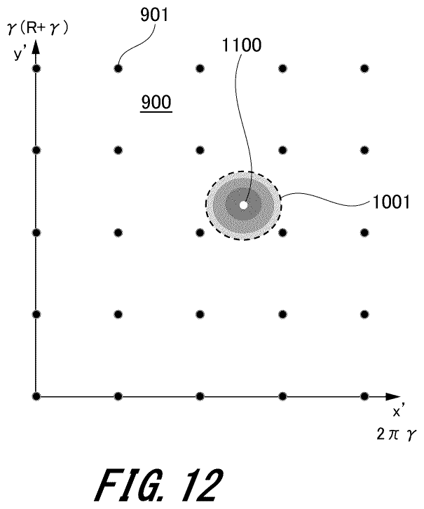

FIG. 12 is a diagram illustrating a state in which image filtering is performed on coordinate system illustrated in FIG. 11 to extract the recession range. The computation unit 127 removes a component (plot) that is equal to or less than a threshold value set in advance, by performing the image filtering on the planar coordinate system. As a result, it is possible to remove an unnecessary plot and to emphasize the range of recession.

A point 1100 illustrated in FIG. 12 is a place where the sum of the values of the attenuation rate is the largest. This point 1100 substantially corresponds to the point where the depth of recession is the deepest. Thus, it is possible to easily detect a portion of the deepest recession. By the processes up to Step S14, the computation unit 127 two-dimensionally estimates (detects) the range of recession and estimates (detects) the deepest position of recession.

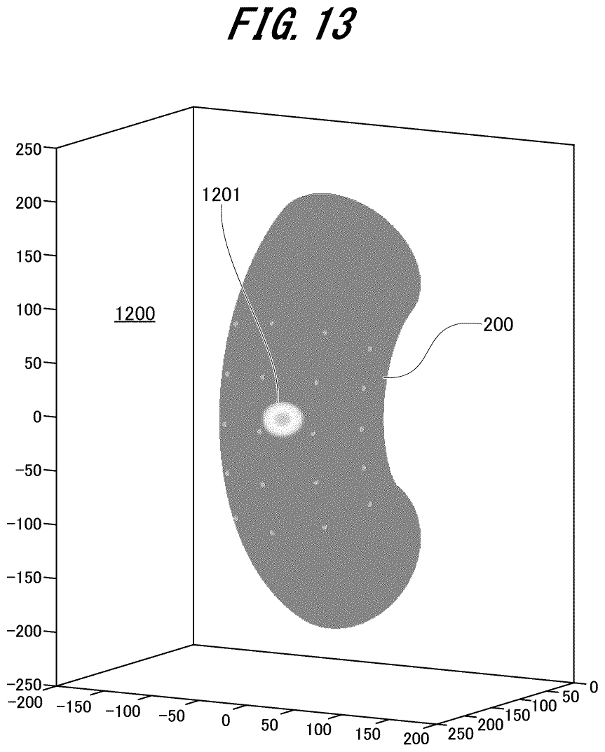

FIG. 13 is a diagram illustrating a state in which a state where the recession range illustrated in FIG. 12 is extracted again is converted into a three-dimensional coordinate system 1200. As illustrated in FIG. 13, by displaying a recession range 1201 in the three-dimensional coordinate system 1200, the inspector can easily recognize where the recession exists in the pipe 200. With such a three-dimensional display, it is possible to change the position and the size of the pipe 200 by an operation unit such as a mouse of a computer. As a result, the inspector can confirm the recession range 1201 from any angle with any size.

In recent years, attempts to three-dimensionally predict the occurrence place of recession by computational fluid dynamics (CFD) have also been made. The recession range 1201 by the three-dimensional display according to the present embodiment can be easily compared with an analysis result by CFD. As a result, the three-dimensional display of the recession range 1201 according to the present embodiment can be utilized for verification of the analysis result by CFD.

Then, the computation unit 127 calculates the depth of recession based on the attenuation rate at the deepest position of recession (S15 in FIG. 8). As a result, the computation unit 127 can detect the depth of the deepest position of the recession. After the process of Step S15, the ultrasonic transmission and reception device 120 ends the recession distribution measurement process.

The attenuation rate calculated in Step S12 is influenced by the recession shape. Therefore, even if the depth of the deepest portion is the same, the obtained attenuation rate is different. In the present embodiment, the recession depth is conservatively calculated by using this point. That is, the recession depth is set to a value with a margin so as not to be shallower than the actual recession depth.

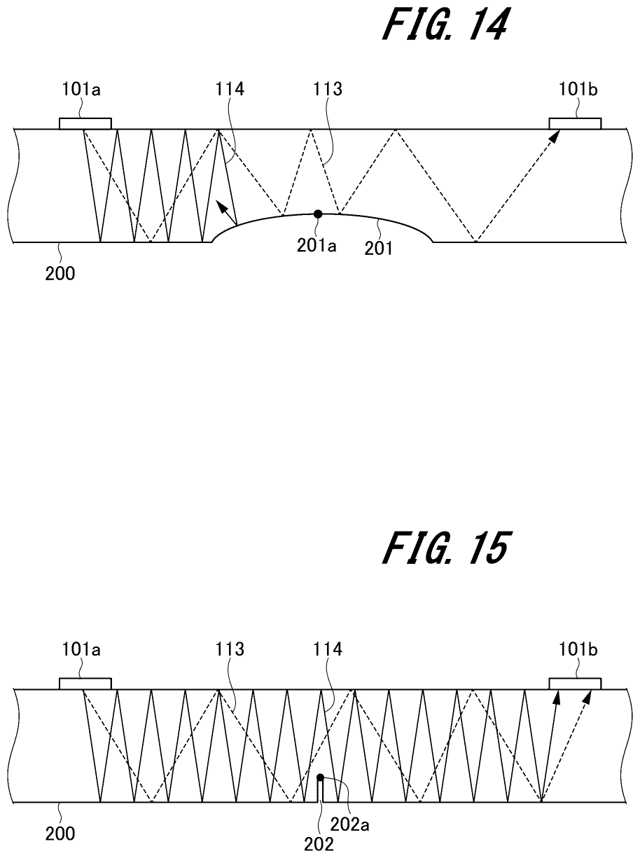

FIG. 14 is a diagram illustrating propagation of an ultrasonic wave emitted from the vertical probe 101a in a case where elliptical recession 201 has occurred in the pipe 200. As illustrated in FIG. 14, the elliptical recession 201 has occurred in the pipe 200. The deepest portion 201a of the recession 201 is the deepest portion of the recession 201.

The ultrasonic wave emitted from the vertical probe 101a includes an ultrasonic wave 113 and an ultrasonic wave 114 having different emission angles. The ultrasonic wave 113 passes over the recession 201 and is received by the vertical probe 101b. The ultrasonic wave 114 is reflected by the inclined surface of the recession 201 and propagates in a direction opposite to the vertical probe 101b side. Thus, the ultrasonic wave 114 is not received by the vertical probe 101b.

As in the case of the ultrasonic wave 114, the larger the inclined area of the recession is, the more the ultrasonic wave reflected by the inclined surface of the recession 201 is generated. On the other hand, even if the deepest portion of the recession has the same depth, the less the inclined surface is, the less the ultrasonic wave is reflected by the recession and the propagation direction changes to the opposite direction. That is, even if the deepest portion of the recession has the same depth, the attenuation rate is different.

FIG. 15 is a diagram illustrating propagation of an ultrasonic wave emitted from the vertical probe 101a in a case where slit-shaped recession 202 has occurred in the pipe 200. As illustrated in FIG. 15, elliptical recession 202 has occurred in the pipe 200. The deepest portion 202a of the recession 202 is the deepest portion of the recession 202. The depth of the deepest portion 202a is the same as the depth of the deepest portion 201a of the recession 201 illustrated in FIG. 14.

The ultrasonic wave emitted from the vertical probe 101a includes an ultrasonic wave 113 and an ultrasonic wave 114 having different emission angles. The ultrasonic waves 113 and 114 illustrated in FIG. 15 have the same emission angle as the ultrasonic waves 113 and 114 illustrated in FIG. 14. As illustrated in FIG. 15, the slit-shaped recession 202 has a smaller inclination area than the recession 201. Therefore, the ultrasonic waves 113 and 114 pass over the recession 202 and are received by the vertical probe 101b.

As described above, the ultrasonic wave that is reflected by the slit-shaped recession 202 and has a propagation direction changed to the opposite direction is smaller than the ultrasonic wave that is reflected by the elliptical recession 201 (see FIG. 14) and has a propagation direction changed to the opposite direction. Thus, in a case where the slit-shaped recession 202 has occurred, the attenuation rate of the ultrasonic waveform signal output from the vertical probe 101b is smaller than that in the case where the elliptical recession 201 has occurred. In other words, even if the attenuation rate of the ultrasonic waveform signal is the same, the deepest depth differs depending on the shape of the recession.

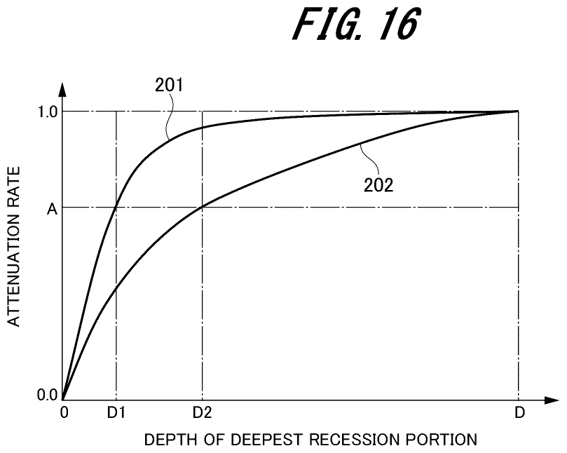

FIG. 16 is a graph showing a relationship between the attenuation rate according to the shape of recession and the depth of recession. In FIG. 16, the horizontal axis indicates the depth of the deepest portion of the recession, and the vertical axis indicates the attenuation rate. As illustrated in FIG. 16, the attenuation rate increases as the depth of the deepest portion of the recession increases.

For example, in a case where the attenuation rate is A, the depth D1 of the deepest portion of the elliptical recession 201 is smaller than the depth D2 of the deepest portion of the slit-shaped recession 202 (D1<D2). Then, in a case where the values of the attenuation rate are the same, the depth of the deepest portion of the elliptical recession 201 is always smaller than the depth of the deepest portion of the slit-shaped recession 202.

Thus, in the present embodiment, assuming that the recession has a slit shape, the depth of the deepest portion of the recession is calculated from the attenuation rate of the ultrasonic waveform signal. That is, assuming that the depth of the deepest portion of the recession is the deepest, the depth of the deepest portion of the recession is calculated. As a result, it is possible to prevent an occurrence of a situation in which the calculated depth of the deepest portion of the recession is shallower than the actual depth of the deepest portion of the recession. As a result, it is possible to repair or replace the pipe before the recession becomes deeper than the allowable range.

### 2. Second Embodiment

An inspection apparatus according to a second embodiment has the same configuration as the inspection apparatus according to the first embodiment. The inspection apparatus according to the second embodiment is different from the inspection apparatus according to the first embodiment in that measurement of an ultrasonic waveform signal is divided into a plurality of times. Therefore, here, a range for measuring the ultrasonic waveform signal will be described, and the description overlapping with the first embodiment will be omitted.

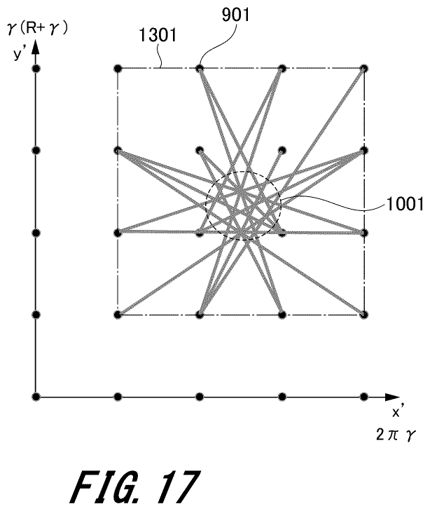

FIG. 17 is a diagram illustrating a result of plotting a value of an attenuation rate on a straight line connecting positions 901 of two probes in all combinations of positions 901 of two probes in a measurement range according to the second embodiment. In FIG. 17, a straight line in which the value of the attenuation rate is 0 is not drawn. In addition, FIG. 17 illustrates a straight line in which the value of the attenuation rate is more than 0, that is, a straight line 1002 crossing a recession range 1001.

As illustrated in FIG. 17, in the second embodiment, a measurement range 1301 that is a region smaller than a region where a plurality of vertical probes 101 are arranged is set. The measurement range 1301 has a size including the positions 901 (some of the plurality of vertical probes 101) of the vertical probes 101 of four rows and four columns. Then, in the second embodiment, the number of ultrasonic waveform signals measured at a time is the number of combinations of the positions 901 of the plurality of vertical probes 101 included in the measurement range 1301.

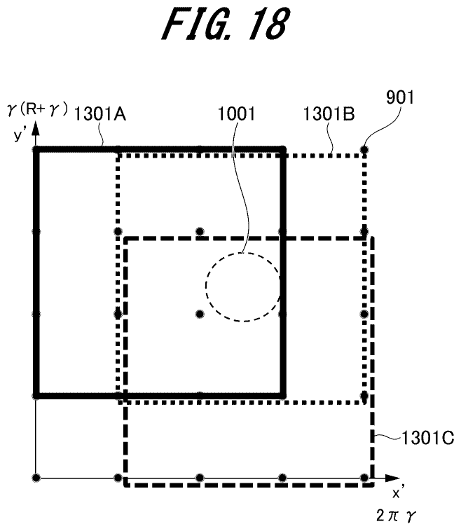

FIG. 18 is a diagram for describing an example of measuring ultrasonic waveform signals at all positions of a plurality of vertical probes 101 by shifting the measurement range 1301 according to the second embodiment. As illustrated in FIG. 18, in the second embodiment, Steps S11 to S15 illustrated in FIG. 8 are repeated while shifting the measurement range 1301. As a result, ultrasonic waveform signals at all positions of the plurality of vertical probes 101 installed on the pipe 200 are measured, and the recession range 1001 is extracted.

For example, first, ultrasonic waveform signals of a plurality of vertical probes 101 within a measurement range 1301A are measured, and a recession range is extracted. Then, ultrasonic waveform signals of a plurality of vertical probes 101 within a measurement range 1301B are measured, and a recession range is extracted. Then, ultrasonic waveform signals of a plurality of vertical probes 101 within a measurement range 1301C are measured, and a recession range is extracted. Then, after the regions of all the vertical probes 101 are measured, the recession ranges extracted in the respective measurement ranges are overlapped to finally extract the recession range 1001.

Note that the repeating step may be only Step S11. In this case, the ultrasonic waveform signals of all the vertical probes 101 are recorded, and then the processes in and after Step S12 are executed. Furthermore, the repeating step can be appropriately set, such as Step S11 and Step S12.

As illustrated in FIGS. 17 and 18, the measurement range 1301 in the second embodiment is set to have a size including the positions of sixteen vertical probes 101 in four rows and four columns. However, the size of the measurement range can be appropriately set according to the dimension of the pipe to be inspected and the measurement situation, for example, a range of two rows and two columns, a range of three rows and six columns, a range other than a rectangle, and the like. In addition, the size of the measurement range does not need to be constant, and the sizes of the first measurement range and the second measurement range may be different.

Also in the inspection apparatus according to the second embodiment, it is possible to obtain the similar effects to those of the first embodiment. That is, according to the inspection apparatus according to the second embodiment, it is possible to two-dimensionally detect the range in which the recession has occurred and calculate the depth of the recession. In addition, in the second embodiment, it is possible to reduce the number of ultrasonic waveform signals to be measured at a time, and thus it is possible to suppress the processing capacity of the ultrasonic waveform recording unit 125 and the computation unit 127.

Hitherto, the inspection apparatus and the inspection method in the present invention have been described including the operational effects thereof. However, the inspection apparatus and the inspection method in the present invention is not limited to the above-described embodiment, and various modifications can be made without departing from the gist of the invention described in the claims.

Further, in the present invention, some components in one embodiment can be replaced with the components in another embodiment, and the configuration of another embodiment can be added to the configuration of one embodiment. In addition, in the present invention, regarding some components in the embodiments, other components can be added, deleted, and replaced.

Note that, in the present specification, words such as “parallel” and “perpendicular” are used, but these words do not strictly mean only “parallel” and “perpendicular”, and may be in a state of being “substantially parallel” or “substantially perpendicular” including “parallel” and “perpendicular” and in a range in which the function can be exhibited.

### REFERENCE SIGNS LIST

1 inspection apparatus
100 probe group
101, 101a, 101b vertical probe
111, 112, 113, 114 ultrasonic wave
120 ultrasonic transmission and reception device
121 changeover switch
122 pulsar receiver
123 multiplexer
124 amplifier
125 ultrasonic waveform recording unit
126 storage unit
127 computation unit
140 signal line
200 pipe
201, 202 recession
201a, 202a deepest portion
601, 602 ultrasonic waveform
900 planar coordinate system
1001 recession range
1100 point
1200 three-dimensional coordinate system
1201 recession range
1301, 1301A, 1301B, 1301C measurement range

1. An inspection apparatus that inspects non-destruction of an inspection target object, the inspection apparatus comprising:
a probe group including a plurality of probes that are attached to be perpendicular to a surface of the inspection target object, and transmit and receive ultrasonic waves;
a recording unit that records a plurality of reception signals obtained by receiving an ultrasonic wave transmitted from a first probe included in the probe group by a plurality of probes other than the first probe; and
a computation unit that calculates a plurality of attenuation indexes representing degrees of attenuation of a plurality of second reception signals received after a plurality of first reception signals, with respect to the plurality of first reception signals recorded before an occurrence of recession in the inspection target object among the plurality of reception signals, and estimates a range of the recession based on the plurality of attenuation indexes.

2. The inspection apparatus according to claim 1, wherein the computation unit calculates the attenuation index by dividing a difference between the first reception signal and the second reception signal corresponding to the first reception signal by the second reception signal.

3. The inspection apparatus according to claim 1, wherein the computation unit plots each attenuation index on a straight line connecting the first probe and a plurality of probes other than the first probe in a planar coordinate system, and detects the range of the recession based on a range in which straight lines overlap.

4. The inspection apparatus according to claim 3, wherein the computation unit sums up the attenuation indexes at points where the straight lines intersect, and detects a point where a sum value of the attenuation indexes is the largest, as a portion of the deepest recession.

5. The inspection apparatus according to claim 4, wherein the computation unit calculates a depth of the recession based on a largest sum of the sum value of the attenuation indexes.

6. The inspection apparatus according to claim 5, wherein the computation unit calculates the depth of the recession assuming slit-shaped recession.

7. The inspection apparatus according to claim 3, wherein the computation unit removes a component in which the attenuation index is equal to or less than a threshold value.

8. The inspection apparatus according to claim 1, wherein the computation unit defines a measurement range having a size including a part of the probe group, and performs measurement a plurality of times by shifting the measurement range, whereby the recording unit records the plurality of reception signals.

9. An inspection method of inspecting non-destruction of an inspection target object by using a reception signal acquired from a probe group including a plurality of probes that are attached to be perpendicular to a surface of the inspection target object, and transmit and receive ultrasonic waves, the inspection method comprising:
by a recording unit, recording a plurality of reception signals obtained by receiving an ultrasonic wave transmitted from a first probe included in the probe group by a plurality of probes other than the first probe; and
by a computation unit, calculating a plurality of attenuation indexes representing degrees of attenuation of a plurality of second reception signals received after a plurality of first reception signals, with respect to the plurality of first reception signals recorded before an occurrence of recession in the inspection target object among the plurality of reception signals, and estimating a range of the recession based on the plurality of attenuation indexes.
